(19) United States
(12) Patent Application Publication
(10) Pub. No.: US 2026/0320051 A1
(43) Pub. Date: Oct. 15, 2026

(54) DATA HANDLING IN LARGE LANGUAGE MODEL FUNCTION CHAINS

(71) Applicant: RTX BBN Technologies, Inc., Cambridge, MA (US)

(72) Inventor: Joshua Swenson Fasching, Watertown, MA (US)

(21) Appl. No.: 19/467,069

(22) Filed: Feb. 2, 2026

Related U.S. Application Data
(60) Provisional application No. 63/757,074, filed on Feb. 11, 2025.

(51) Int. Cl. G06F 16/2455; G06F 16/215

(52) U.S. Cl. CPC G06F 16/2455; G06F 16/215

(57) ABSTRACT

The described technology relates to data handling in large language model (LLM) function chains, addressing inefficiencies in current methods. The technical problem involves managing intermediate data that can exceed context window limits, leading to data fidelity issues and undesired behaviors. The solution involves a method for passing data between function calls using a shared memory system with universal identifiers (UUIDs) and values, ensuring data integrity and preventing exposure to the LLM's context. This approach enhances the performance of LLMs and the quality of responses. The system includes a user device, a manager LLM, agents, and shared memory. The method involves processing prompts, executing functions, and storing output data with UUIDs, facilitating efficient data handling and argument parsing.

### CROSS-REFERENCE TO RELATED APPLICATIONS

This application claims the benefit of priority to U.S. Application No. 63/757,074 filed Feb. 11, 2025, the disclosure of which is incorporated herein by reference in its entirety.

### BACKGROUND

The present disclosure relates to data handling in large language model (LLM) function chains, specifically to methods for passing data to improve the performance of the LLM and the quality of the responses provided by the LLM.

Advanced models have become increasingly important in various applications, ranging from natural language processing to complex decision-making systems. These models often require the execution of multiple function calls to process and generate responses. However, the current methods for handling data within these processes are inefficient and prone to errors. Specifically, the intermediate data passed between functions can be too large for the context window, leading to data fidelity issues and potential undesired behaviors.

Existing solutions often expose intermediate data to the LLM prompt context, which can compromise the accuracy and reliability of the execution. Additionally, these methods do not adequately address the need for robust argument parsing and data handling, resulting in performance bottlenecks and increased complexity.

### SUMMARY

In one embodiment, a computer-implemented method for data handling in large language model (LLM) function chains is provided. The method includes processing a prompt received by a manager LLM to identify a first function to be executed by one or more agents and transmitting a first function call for the first function to a first agent of the one or more agents. The method also includes executing the first function by the first agent, storing output data from the first function in a shared memory and creating a universal identifier (UUID) and a value associated with the output data, and transmitting the UUID to one or more of the agents and the manager LLM. Additional functions and agents may be chained together in a sequence behaving like the first, storing data into shared memory and passing along the UUID.

In other embodiments, the above described computer-implemented method for data handling in large language model (LLM) function chains is embodied in one or more systems or computer program products.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a block diagram illustrating a system for handling data in LLM function chains.

FIG. 2 is a flow chart diagram illustrating the process of handling data in LLM function chains using shared memory and UUIDs.

FIG. 3 is a flow chart diagram illustrating the process of argument parsing in a shared memory system for LLM function chains.

FIG. 4 illustrates a flow chart diagram of a method for handling data in LLM function chains.

### DETAILED DESCRIPTION

Large Language Models (LLMs) are employed in various applications, including natural language processing and complex decision-making systems. However, the current methods for handling data within these processes have some inefficiencies. Specifically, the intermediate data passed between functions can be too large for the context window, leading to data fidelity issues and potential undesired behaviors. This poses significant challenges in maintaining the accuracy and reliability of the execution, affecting the performance of the LLM and the quality of the responses provided.

Existing solutions often expose intermediate data to the context, which can compromise the integrity of the data and lead to inaccuracies. These methods do not adequately address the need for robust argument parsing and data handling, resulting in performance bottlenecks and increased complexity. Additionally, large matrix data may be too extensive for the context window, and rendering such data in text can lead to a loss of fidelity. Data objects containing pointers to other data objects are only serialized as string references, which doesn't give the LLM full context for interpretation or passing that intermediate information downstream for further processing. An LLM may “hallucinate” or exhibit undesired behavior when presented with intermediate data. These shortcomings highlight the need for a more efficient and reliable method for handling data in LLM function chains.

The present method addresses these issues by introducing a way to pass information between function calls by a LLM without exposing the data to the LLM. This method involves the use of a data structure to store intermediate data from functions in a shared memory along with a universal unique identification (UUID)/value pair. The method also includes a way to design pre-programmed functions selected by the LLM, to accept either UUIDs and/or values as arguments to function calls, and an argument parsing function that can handle these UUIDs and/or values. This approach ensures data fidelity and integrity throughout the function chain, improving the performance of the LLM and the quality of the responses generated.

In exemplary embodiments, methods and systems for handling data in LLM function chains that utilizes a shared memory with UUIDs and values are provided. In exemplary embodiments, intermediate data generated by function calls is stored in a shared memory and can be referenced without exposing the data to the LLM's context. The use of UUIDs to reference stored data minimizes the risk of data fidelity issues and prevents the LLM from “hallucinating” or exhibiting undesired behaviors due to intermediate data exposure. This approach enhances the accuracy and reliability of the LLM's performance when using pre-programmed functions, leading to improved quality of responses. Additionally, the method reduces the complexity of argument parsing and data handling, thereby addressing performance bottlenecks associated with existing solutions.

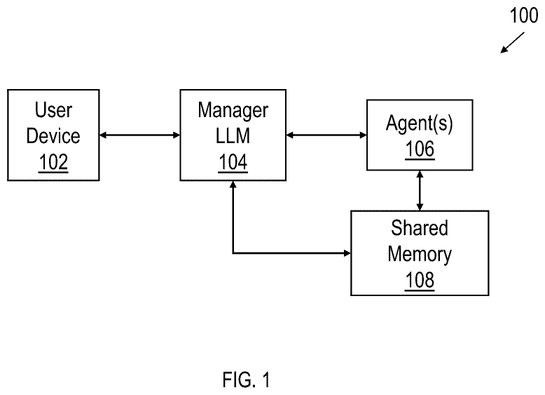

Referring now to FIG. 1, a block diagram illustrating a system 100 for handling data in LLM function chains in accordance with an exemplary embodiment is shown. The system 100 includes a user device 102, a manager LLM 104, one or more agents 106, and a shared memory 108.

In exemplary embodiments, the user device 102 is the interface through which a user interacts with the system 100. The user device 102 can be any computing device capable of receiving user inputs and displaying outputs, such as a personal computer, a smartphone, or a tablet. The user device 102 is responsible for transmitting prompts or queries to the manager LLM 104. These prompts initiate the process of identifying and executing functions by the agents 106.

In exemplary embodiments, the manager LLM 104 is a large language model that processes the prompts received from the user device 102. The manager LLM 104 identifies the functions that need to be executed to respond to the user's prompt. The manager LLM 104 then coordinates the execution of these functions by transmitting function calls to the appropriate agents 106. The manager LLM 104 also receives the results of these function calls, which are stored in the shared memory 108, and uses them to generate a final response to the user.

In exemplary embodiments, the agents 106 are specialized components that execute the functions identified by the manager LLM 104. Each agent 106 can be a specialized LLM, a database, or any other computational entity capable of performing specific tasks. The agents 106 receive function calls from the manager LLM 104, execute the corresponding functions, and store the output data in the shared memory 108.

In exemplary embodiments, the shared memory 108 is a data structure used to store intermediate data generated by the function calls executed by the agents 106. In exemplary embodiments, the shared memory 108 also create UUIDs and values associated with the output data, which are transmitted back to the manager LLM 104 and other agents 106 as needed. In exemplary embodiments, the shared memory 108 is organized as a dictionary with UUID/value pairs, where each UUID identifies a piece of output data. This structure allows the system 100 to reference stored data without exposing the data to the context of the LLM, thereby ensuring data fidelity and preventing undesired behaviors such as hallucinations. The shared memory 108 facilitates efficient data handling and argument parsing by allowing functions to accept either UUIDs or values as arguments.

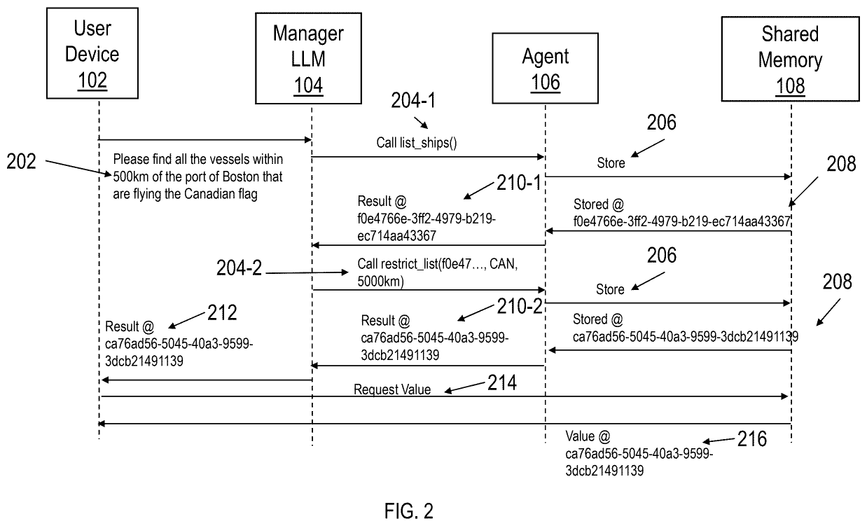

Referring now to FIG. 2, a flow diagram illustrating the process of handling data in a LLM function chain using shared memory and UUIDs. FIG. 2 depicts the interaction between a user device 102, a manager LLM 104, an agent 106, and shared memory 108. The process begins with the user device 102 sending a prompt 202 to the manager LLM 104. In this example, the prompt requests the identification of all vessels within 500 km of the port of Boston that are flying the Canadian flag. The manager LLM 104 processes this prompt and identifies the necessary functions to be executed.

Next, the manager LLM 104 transmits a first function call 204-1 to the agent 106. The first function call is for the function list_ships( ), which retrieves a list of ships. The agent 106 executes this function and performs a store operation 206 to store the resulting output data in the shared memory 108. The output data is stored with a UUID, in this case, f0e4766e-3ff2-4979-b219-ec714aa43367, and the corresponding value. The shared memory 108 transits a storage confirmation 208 to the agent 106, that includes the UUID. The agent 106 then transmits a first function result 210-1 to the manager LLM 104, first function result 210-1 including the UUID of the results of first function 204-1.

Next, the manager LLM 104 transmits a second function call 204-2 to the agent 106. This second function call is for the function restrict_list( ), which filters the list of ships based on the specified criteria (Canadian flag and within 5000 km). The arguments for this function call include the UUID of the previously stored output data, the CAN flag type, and the specified distance of 500 km. The agent 106 retrieves the output data from the shared memory 108 using the UUID and executes the restrict_list( ) function. The resulting output data is again stored using a store operation 206 in the shared memory 108 with a new UUID, ca76ad56-5045-40a3-9599-3dcb21491139, and the corresponding value. The shared memory 108 transits a storage confirmation 208 to the agent 106, that includes the new UUID. Next, the agent 106 then transmits a second function result 210-2 to the manager LLM 104, second function result 210-2 including the UUID of the results of the second function 204-2.

In one embodiment, after the manager LLM 104 receives the second function result 210-2, the manager LLM 104 provides the second function result 210-2 to the user device 102. The user device 102 requests the value associated with the new UUID from the shared memory 108. The shared memory 108 returns the value to the user device 102, completing the process.

In another embodiment, after the manager LLM 104 receives the second function result 210-2, the manager LLM 104 then requests the value associated with the new UUID from the shared memory 108. The shared memory 108 returns the value to the manager LLM 104, which then uses this data to generate a final response to the user device 102. The final response 210 is transmitted back to the user device 102, completing the process.

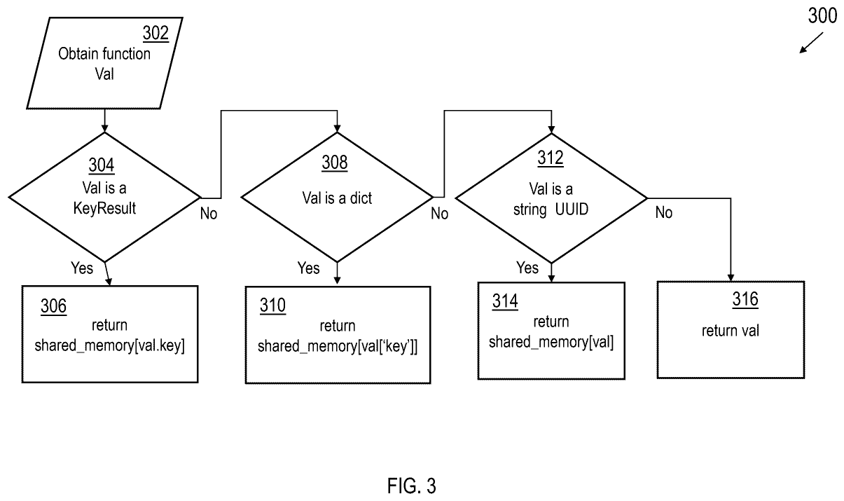

FIG. 3 shows a method 300 for argument parsing in a shared memory system for LLM function chains. The method 300 can be implemented by each agent to handle data efficiently and ensure data fidelity during function execution. In exemplary embodiments, each argument passed to a function is unpacked using method 300 before it is used in computation by that function. At block 302, the method 300 begins by obtaining a function value (Val). This value is the output from a previous function call that needs to be parsed and processed for subsequent function calls.

At block 304, the method 300 checks if Val is a KeyResult, a software object returned by an agent function representing a result in shared memory. If Val is a KeyResult, the method proceeds to block 306, where the value associated with the identifier is returned from the shared memory using the expression shared_memory[val]. If Val is not a KeyResult, the method proceeds to block 308.

At block 308, the method 300 checks if Val is a dictionary software object. If Val is a dictionary, the method proceeds to block 310, where the value associated with ‘key’ is returned from the shared memory using the expression shared_memory [val[‘key’]]. If Val is not a dictionary, the method proceeds to block 312.

At block 312, the method 300 checks if Val is a string UUID. In one embodiment, this is done by a regular expression match uuid4hex=re.compile(r′\hat{ }[a-f0-9]{8}-?[a-f0-9]{4}-?4[a-f0-9]{3}-?[89ab][a-f0-9]{3}-?[a-f0-9]{12}\Z′, re.I). If Val is a string UUID, the method proceeds to block 314, where the value associated with the UUID is returned from the shared memory using the expression shared_memory[val]. If Val is not a string UUID, the method proceeds to block 316.

At block 316, the method 300 returns the value Val as is, indicating that Val does not require any further parsing or retrieval from the shared memory. This step ensures that the method can handle various types of values and return them appropriately.

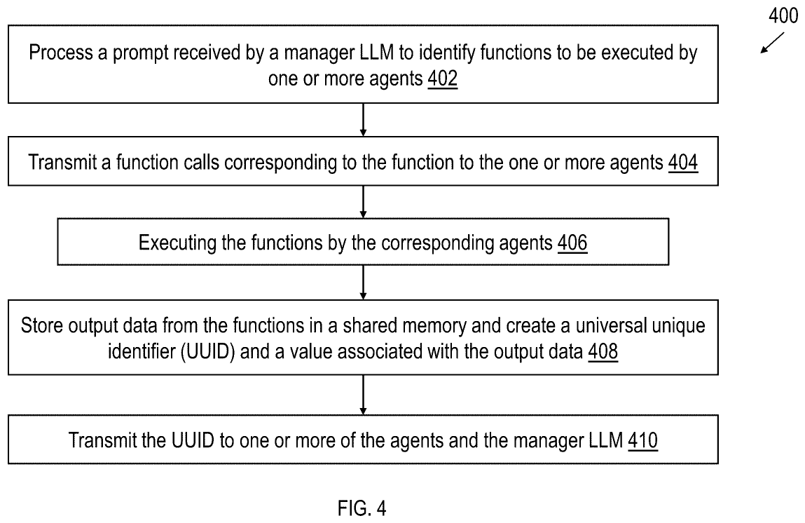

Referring now to FIG. 4, a flow chart diagram of a method 400 for handling data in LLM function chains is shown. The method 400 begins with processing a prompt received by a manager LLM to identify functions to be executed by one or more agents, as shown at block 402.

In exemplary embodiments, the identification and/or selection of functions to be executed by one or more agents can be performed in various ways, depending on the nature of the prompt and the capabilities of the manager LLM. For instance, the manager LLM can analyze the prompt for specific keywords or phrases that indicate the required functions. For example, if the prompt includes the phrase “list all ships,” the manager LLM identifies the function list_ships( ) as necessary for generating the response. Additionally, the manager LLM can use pattern matching techniques to recognize common request patterns and map them to predefined functions. For instance, a prompt asking for “vessels within 500 km of Boston” matches a pattern that triggers the restrict_list( ) function with specific parameters.

The manager LLM can also leverage its natural language understanding capabilities to comprehend the context and intent of the prompt. For example, if the prompt is “find Canadian ships near Boston,” the manager LLM understands the need to first list all ships and then filter them based on location and flag criteria. Another approach involves maintaining a dependency graph of functions, where each function's output serves as an input to another function. Based on the prompt, the manager LLM traverses the graph to identify the sequence of functions required to generate the response. For example, the prompt “calculate the average speed of ships” may require functions to list ships, retrieve their speeds, and compute the average.

Moreover, the manager LLM can employ machine learning models trained on historical data to predict the functions needed for a given prompt. For example, a model trained on past interactions can predict that a prompt about “ship locations” typically requires the list_ships( ) and restrict_list( ) functions. Rule-based systems can also be used, where the manager LLM follows a set of predefined rules to determine the functions required for the prompt. For example, a rule might state that any prompt mentioning “distance” and “location” should trigger the calculate_distance( ) function.

In addition, the manager LLM can consider user profiles and preferences to tailor the function selection process. For example, if a user frequently requests data about “cargo ships,” the manager LLM prioritizes functions related to cargo ship information. By employing these techniques, the manager LLM can accurately identify and select the appropriate functions to be executed by the agents, ensuring that the response generated is relevant and accurate.

Next, as shown at block 404, the method 400 involves transmitting function calls corresponding to the identified functions to the one or more agents. The manager LLM sends these function calls to the appropriate agents, which are responsible for executing the functions. This step ensures that the tasks are distributed among the agents, leveraging their specialized capabilities to perform specific operations. By distributing the tasks among specialized agents, the manager LLM ensures that each function is executed efficiently and accurately, leveraging the unique strengths of each agent to achieve optimal performance.

As shown at block 406, the method 400 also includes the agents executing the functions as per the received function calls. In exemplary embodiments, each agent performs the assigned function, generating output data as a result. Next, as shown at block 408, the method 400 further includes storing the output data from the functions in a shared memory and creating a UUID and a value associated with the output data. The shared memory serves as a centralized repository for the intermediate data generated by the agents. By creating UUIDs and mapping to values for the output data, the method 400 ensures that the data can be referenced without exposing the data to the LLM's context, thereby maintaining data fidelity and preventing undesired behaviors.

Once the output data of a function has been stored in the shared memory, the UUID is then transmitted to one or more of the agents and the manager LLM 410. This step allows the agents and the manager LLM to access the stored data using the UUIDs, facilitating efficient data handling and argument parsing. The transmission of UUIDs ensures that the data can be retrieved from shared memory and used in subsequent function calls without compromising integrity.

In exemplary embodiments, the function calls transmitted to the agents include zero, one or more arguments that include UUIDs and values, enabling the agents to retrieve the necessary data from the shared memory to execute the corresponding functions. Parsing the arguments of a function call involves determining a type of each of the arguments to ensure that the correct data is retrieved and used in the function execution. The parsing process is designed to allow the functions to handle different types of arguments, such as UUIDs, values, dictionaries, and string UUIDs.

In exemplary embodiments, the method 400 may also include deleting the output data from the shared memory based on a determination that the manager LLM has provided a response to the prompt. This step involves removing the data from the shared memory once no longer needed, ensuring that the memory is used efficiently and preventing unnecessary data accumulation. For example, after the manager LLM processes a prompt requesting the identification of all vessels within 500 km of the port of Boston that are flying the Canadian flag, it coordinates the execution of the necessary functions and generates the final response. Once the response is transmitted back to the user device, the manager LLM determines that the intermediate data stored in the shared memory, such as the list of ships and the filtered results, is no longer required. Consequently, the manager LLM initiates the deletion of this data from the shared memory, freeing up space for future function calls and data storage. This ensures that the shared memory remains optimized and prevents the accumulation of obsolete data, thereby maintaining the system's efficiency and performance.

In various embodiments, the user device is configured to display the results received from the manager LLM. For instance, in one embodiment, the user device could be a personal computer equipped with a monitor, providing a detailed and interactive graphical user interface (GUI) that allows users to visualize complex data and interact with the system through a combination of keyboard and mouse inputs. In another embodiment, the user device could be a smartphone or tablet, offering a touch-based interface that supports gestures and swipes for a more intuitive user experience, particularly useful for on-the-go access to the system. Additionally, the user device could be integrated into a wearable device, such as a smartwatch or augmented reality (AR) glasses, providing users with real-time notifications and data overlays in a hands-free manner. In yet another embodiment, the user device could be a voice-activated smart speaker, where the results from the manager LLM are conveyed through auditory feedback, making it accessible for users who prefer or require voice interaction. Furthermore, the user device could be part of a larger control system in industrial or commercial settings, such as a control panel in a manufacturing plant or a dashboard in a logistics center, where the results are displayed on large screens or multiple monitors to facilitate monitoring and decision-making by multiple users. Each of these embodiments ensures that the user device is adaptable to various contexts and user preferences while maintaining the primary functionality of displaying results from the manager LLM.

In various embodiments, the manager LLM can preprocess the prompts to remove irrelevant data before identifying functions in several ways. In one embodiment, the manager LLM employs natural language processing (NLP) techniques to analyze the prompt and filter out extraneous information, ensuring that only relevant data is considered for function identification. This can involve tokenization, part-of-speech tagging, and named entity recognition to isolate elements of the prompt. In another embodiment, the manager LLM utilizes machine learning algorithms trained on historical data to recognize patterns of irrelevant data and automatically exclude them from the prompt. This approach can be particularly effective in adapting to different user inputs and improving over time. Additionally, the manager LLM can implement rule-based systems where predefined rules are applied to strip out common irrelevant phrases or words, such as greetings or filler words, before processing the prompt. In yet another embodiment, the manager LLM can incorporate user-specific customization, where it learns from individual user interactions to better understand and filter out data that is typically irrelevant for that user. This personalized preprocessing ensures that the function identification process is tailored to the user's communication style. Furthermore, the manager LLM can integrate context-aware preprocessing, where it considers the context of previous interactions to determine the relevance of data in the current prompt, thereby enhancing the accuracy and efficiency of function identification.

In various embodiments, the manager LLM can utilize machine learning algorithms to enhance the accuracy of function identification over time. One embodiment involves the use of supervised learning models trained on historical data of user prompts and corresponding function calls. These models can predict the most relevant functions based on the context and content of new prompts. Another embodiment employs reinforcement learning, where the manager LLM continuously learns from interactions and feedback, adjusting function identification strategies to maximize accuracy and efficiency. In yet another embodiment, the manager LLM can implement unsupervised learning techniques to cluster similar prompts and identify common function patterns, thereby improving the ability to handle new and diverse prompts. Additionally, the manager LLM can integrate transfer learning, where pre-trained models on related tasks are fine-tuned with specific data to enhance function identification capabilities. The system can also incorporate ensemble learning, combining multiple machine learning models to achieve a consensus on the most appropriate functions, thereby increasing robustness and reliability. These embodiments ensure that the manager LLM adapts and evolves, providing more accurate and contextually relevant function identification over time.

In various embodiments, the manager LLM can maintain a log of all function calls and results for auditing and debugging purposes in several ways. In one embodiment, the log can be stored in a centralized database that is accessible to system administrators and developers for real-time monitoring and historical analysis. This database can be implemented using SQL or NoSQL technologies, depending on the scalability and performance requirements. In another embodiment, the log can be distributed across multiple nodes in a decentralized manner, using blockchain technology to ensure data integrity and immutability. This approach can be particularly useful in environments where security and tamper-proof records are important. Additionally, the log entries can include detailed metadata such as timestamps, function call parameters, execution durations, and error codes, providing comprehensive insights into the system's operations. In yet another embodiment, the logging mechanism can be integrated with existing enterprise logging solutions, such as ELK (Elasticsearch, Logstash, Kibana) stack or Splunk, to leverage advanced search, visualization, and alerting capabilities. Furthermore, the manager LLM can employ machine learning algorithms to analyze the log data and identify patterns or anomalies, enabling proactive issue detection and performance optimization. The logging system can also support configurable retention policies, allowing administrators to define how long log data is retained based on regulatory requirements or storage constraints. Each of these embodiments ensures that the logging mechanism is robust, scalable, and adaptable to various operational contexts, thereby enhancing the overall reliability and maintainability of the LLM function chain system.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

What is claimed is:

1. A computer-implemented method for data handling in large language model (LLM) function chains, the method comprising:
processing a prompt received by a manager LLM to identify a first function and a second function to be executed by one or more agents;
transmitting a first function call for the first function to a first agent of the one or more agents;
executing the first function by the first agent;
storing an output data from the first function in a shared memory and creating a universal unique identifier (UUID) and a value associated with the output data; and
transmitting the UUID to one or more of the first agent and the manager LLM.

2. The computer-implemented method of claim 1, further comprising:
transmitting a second function call for a second function to one or more of the first agent or a second agent, wherein the second function call includes arguments that include at least the UUID;
parsing the arguments the second function call;
retrieving the output data from the shared memory and executing the second function;
storing a second output data from the second function in the shared memory and creating a second UUID and a second value associated with the second output data; and
transmitting the UUID to one or more of the first agent, the second agent, and the manager LLM.

3. The computer-implemented method of claim 1, wherein parsing arguments of the second function call comprises determining a type of the arguments.

4. The computer-implemented method of claim 1, wherein the shared memory comprises a dictionary with UUID value pairs corresponding to each stored output data.

5. The computer-implemented method of claim 1, wherein the one or more agents are special purpose LLMs.

6. The computer-implemented method of claim 1, wherein the one or more agents are databases.

7. The computer-implemented method of claim 1, wherein the one or more agents are functions.

8. The computer-implemented method of claim 1, further comprising deleting the output data from the shared memory based on a determination that the manager LLM has provided a response to the prompt.

9. A system for handling data in large language model (LLM) function chains, the system comprising:
a user device configured to transmit prompts to a manager LLM;
the manager LLM configured to:
process the prompts received from the user device to identify a first function and a second function to be executed by one or more agents;
transmit a first function call for the first function to a first agent of the one or more agents; and
receive a first function result from the first agent, the first function result including a universal unique identifier (UUID) associated with output data from the first function;
the one or more agents configured to:
execute the first function in response to the first function call;
store the output data from the first function in a shared memory, the shared memory comprising a dictionary with UUID/value pairs;
transmit the UUID associated with the output data to the manager LLM;
the shared memory configured to:
store intermediate data generated by the function calls executed by the one or more agents; and
provide the stored data to the one or more agents and the manager LLM based on the UUIDs.

10. The system of claim 9, wherein the manager LLM is further configured to:
transmit a second function call for the second function to one or more of the first agent and a second agent, wherein the second function call includes arguments that include at least the UUID;
parse the arguments of the second function call to determine a type of the arguments;
retrieve the output data from the shared memory and execute the second function;
store a second output data from the second function in the shared memory and create a second UUID and a second value associated with the second output data; and
transmit the second UUID to one or more of the first agent, the second agent, and the manager LLM.

11. The system of claim 9, wherein the system is configured to delete the output data from the shared memory based on a determination that the manager LLM has provided a response to the prompt.

12. The system of claim 9, wherein the user device is further configured to display the results received from the manager LLM.

13. The system of claim 10, wherein the manager LLM is further configured to preprocess the prompts to remove irrelevant data before identifying functions.

14. The system of claim 11, wherein the manager LLM is further configured to use machine learning algorithms to improve the accuracy of function identification over time.

15. The system of claim 12, wherein the manager LLM is further configured to maintain a log of all function calls and results for auditing and debugging purposes.

16. The system of claim 13, wherein the one or more agents are specialized for different types of functions, such as data retrieval, data processing, or data analysis.
